(19) United States
(12) Patent Application Publication
(10) Pub. No.: US 2016/0021818 A1
(43) Pub. Date: Jan. 28, 2016

(54) BRUSH CUTTING BLADES

(71) Applicant: Dana Salsbery, Tidewater, OR (US)

(72) Inventor: Dana Salsbery, Tidewater, OR (US)

(21) Appl. No.: 14/801,074

(22) Filed: Jul. 16, 2015

Related U.S. Application Data
(60) Provisional application No. 61/999,263, filed on Jul. 22, 2014.

(51) Int. Cl. A01D 34/73

(52) U.S. Cl. CPC A01D 34/73

(57) ABSTRACT

Brush cutting blades that are attachable to a brush cutting device to drive rotation of the blade are shown and described. Each of the blades includes a planar main body, upwardly projected teeth upwardly disposed relative to the planar main body, and downwardly projected teeth downwardly disposed relative to the planar main body. The upwardly and downwardly disposed teeth are disposed on a periphery of the planar main body. In some examples, the blade includes planar teeth aligned with the planar body. In some further examples, planar teeth are alternatingly disposed between the one or more upwardly projected teeth and the one or more downwardly projected teeth.

### CROSS REFERENCE TO RELATED APPLICATIONS

This application claims priority to and the benefit under 35 U.S.C. §119(e) of copending U.S. Provisional Patent Application Ser. No. 61/999,263, filed on Jul. 22, 2014, which is hereby incorporated by reference for all purposes.

### BACKGROUND

The present disclosure relates generally to blades for a brush cutting device configured to rotate the blade. In particular, blades with alternatingly upwardly disposed teeth and downwardly disposed teeth are described.

Known brush cutting blades are not entirely satisfactory for the range of applications in which they are employed. For example, existing blades are planar and include peripheral teeth that are aligned with (i.e., disposed in the same plane as) the planar blade body. Thus, using conventional blades, clearing of brush occurs only in the horizontal plane of the blade. Accordingly, clearing of brush may be time consuming. Additionally, conventional blades create large segments of debris during clearing that may require further processing.

Thus, there exists a need for brush cutting blades that improve upon and advance the design of known blades. Examples of new and useful brush cutting blades relevant to the needs existing in the field are discussed below.

### SUMMARY

The present disclosure is directed to brush cutting blades that are attachable to a brush cutting device to drive rotation of the blade, each of the blades including a planar main body, upwardly projected teeth upwardly disposed relative to the planar main body, and downwardly projected teeth downwardly disposed relative to the planar main body. The upwardly and downwardly disposed teeth are disposed on a periphery of the planar main body. In some examples, the blade includes planar teeth aligned with the planar body. In some further examples, planar teeth are alternatingly disposed between the one or more upwardly projected teeth and the one or more downwardly projected teeth.

### BRIEF DESCRIPTION OF THE DRAWINGS

FIG. 1 is a perspective view of a first example a brush cutting device.

FIG. 2 is a perspective view of a first example of a brush cutting blade used in combination with the brush cutting device shown in FIG. 1.

FIGS. 3A and 3B are top plan and side elevation views, respectively, of the first example brush cutting blade shown in FIG. 2.

FIG. 4 is a perspective view of a second example of a brush cutting blade.

FIGS. 5A and 5B are top plan and side elevation views, respectively, of the second example brush cutting blade shown in FIG. 4.

FIG. 6 is a perspective view of a third example of a brush cutting blade.

FIGS. 7A and 7B are top plan and side elevation views, respectively, of the third example brush cutting blade shown in FIG. 6.

FIG. 8 is a perspective view of a fourth example of a brush cutting blade.

FIGS. 9A and 9B are top plan and side elevation views, respectively, of the fourth example brush cutting blade shown in FIG. 8.

FIG. 10 is a perspective view of a fifth example of a brush cutting blade.

FIGS. 11A and 11B are top plan and side elevation views, respectively, of the fifth example brush cutting blade shown in FIG. 10.

### DETAILED DESCRIPTION

The disclosed brush cutting blades will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various brush cutting blades are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

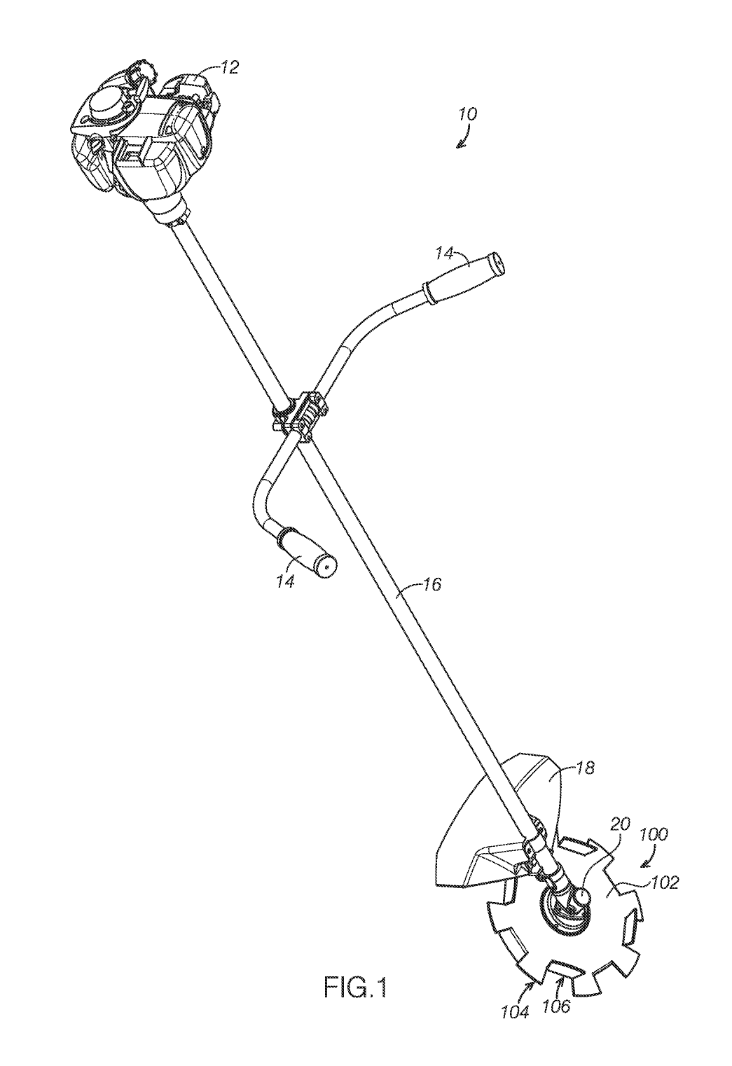

With reference to FIGS. 1-11B, first, second, third, fourth, and fifth examples of brush cutting blades (i.e., brush cutting blades 100, 200, 300, 400, and 500) are shown and described. The example brush cutting blades function to cut brush and/or other plant and organic material in multiple planes and/or directions. Additionally or alternatively, the example brush cutting blades can be used as “chippers” to reduce the size of brush and plant debris.

The reader will appreciate from the figures and description below that the example brush cutting blades of the present application address many of the shortcomings existing with conventional brush cutting blades. For example, as the presently described brush cutting blades include upwardly projected teeth and downwardly projected teeth, the blades cut in the horizontal and vertical planes of the blade body. Accordingly, a time required to carry out brush clearing is reduced. Further, brush segments of debris are reduced in size compared to debris from conventional brush cutting blades.

FIGS. 1-3B, a first example of a brush cutting blade, blade 100, will now be described. FIG. 1 shows blade 100 rotatably attached to a brush cutting device 10. Brush cutting device 10 is configured to drive rotation of blade 100 and includes a motor 12, handles 14, a support rod 16, a debris shield 18, and a blade attachment mechanism 20. A user can selectively turn on the power to the motor and manipulate the handles to direct the cutting action of blade 100. In other examples, the brush cutting device can include additional or alternative features, such as a shoulder strap and/or safety shielding devices, etc.

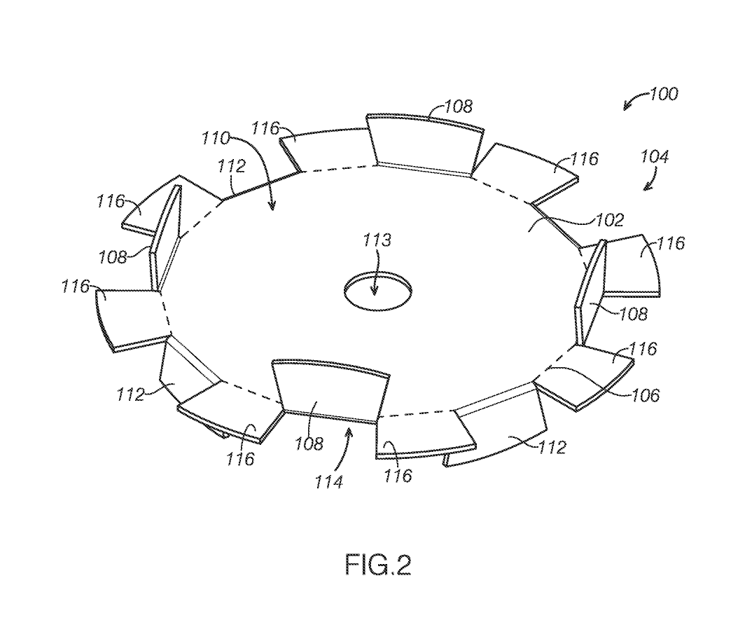

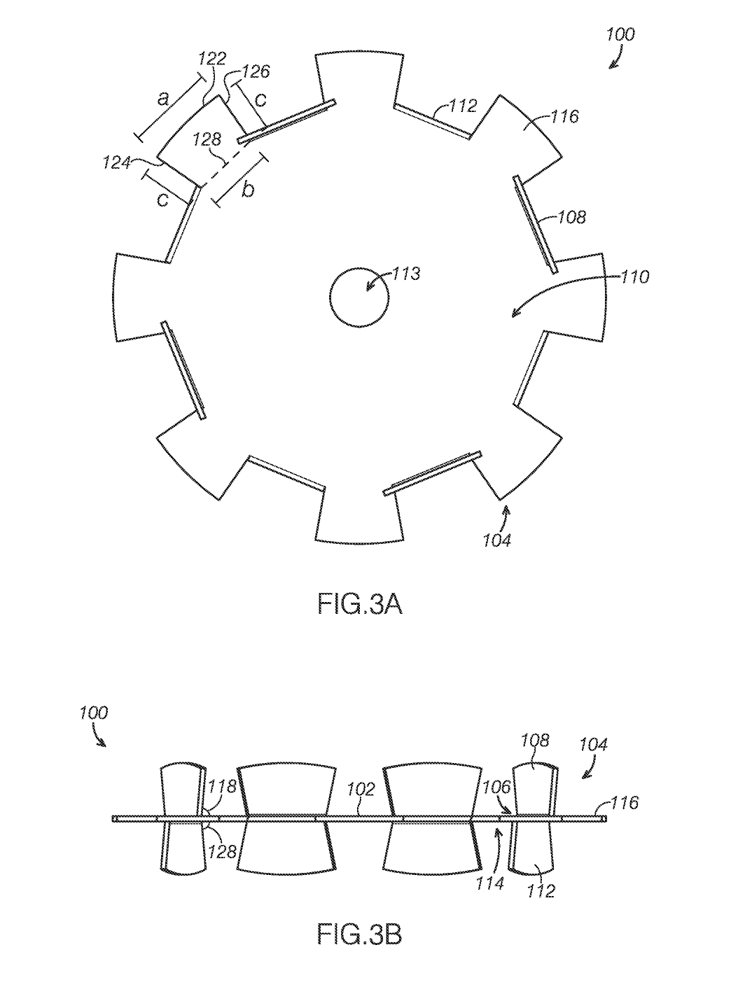

As can be seen in FIG. 1, blade 100 includes a planar main body 102 and teeth 104 on a periphery 106 of the planar main body. FIGS. 2-3B show that teeth 104 include a plurality of upwardly projected teeth 108 proximal to a first face 110 of the planar main body, a plurality of downwardly projected teeth 112 proximal to a second opposing face 114, and a plurality of planar teeth 116. Planar teeth 116 are substantially aligned with (i.e., in the same plane as) planar main body 102. Further, upwardly projected teeth 108 are upwardly disposed relative to planar main body 102, while downwardly projected teeth 112 are downwardly disposed relative to planar main body 102. Further, a center of the planar main body includes a hole 113 for attachment of the blade to the brush cutting device.

It will be appreciated that, in the example of blade 100, the upwardly projected teeth and the downwardly projected teeth have a substantially similar configuration on opposing sides (i.e., opposing faces) of planar main body 102. Accordingly, the terms “upwardly” and “downwardly” are used merely to describe the orientation shown in the figures and the blade can be disposed at any desired orientation. In one specific example, the blade can be flipped such that the opposing face of the blade is upwardly disposed. In this example, teeth 108 can be downwardly disposed, while teeth 112 are upwardly disposed.

Furthermore, in the present example, each of planar teeth 116 is alternatingly disposed between one of upwardly projected teeth 108 and one of downwardly projected teeth 112, and the teeth are evenly spaced on the periphery of the planar main body. Accordingly, the teeth are evenly disposed in a specific distribution pattern (i.e., one of the upwardly projected teeth adjacent to one of the planar teeth, which is adjacent to one of the downwardly projected teeth, etc.). In alternate examples, the teeth can be unevenly spaced and/or the have a different distribution pattern (e.g., one of the upwardly projected teeth, one of the downwardly projected teeth, one of the planar teeth, etc.).

FIG. 3B shows that upwardly projected teeth 108 are disposed at an angle 118 relative to first face 110 and downwardly projected teeth 112 are disposed at an angle 120 relative to second face 114. Angles 118 and 120 can be in the range of 45°-135°. In the present example, angles 118 and 120 are substantially 90° angles. Further in the present example, angles 118 and 120 are substantially identical for each of teeth 109 and 112. In alternate examples, angles 118 and 120 can be greater or less than 90° (e.g., 45°, 135°, etc.). Additionally or alternatively, in alternate examples, the upwardly projected and downwardly projected teeth can be disposed at varied angles relative to the planar main body.

Also depicted in FIGS. 3A and 3B, each of teeth 108, 112, and 116 have a substantially similar shape relative to each other. Specifically, each of the teeth has a generally slightly tapered rectangular configuration including a curved outer edge 122, linear side edges 124 and 126, and an inner edge 128 where each of the teeth is connected and/or coextensive with periphery 106. Each of the teeth flares and/or outwardly widens. Accordingly, a width a of curved outer edge 122 is greater than a width b of inner edge 126. Each of the side edges 124 and 126 has a length c. In one specific example, the width a is 2 in., the width b is 1¾ in., and the length c is 1½ in.

Further, in the example of blade 100, the blade includes four upwardly projected teeth, four downwardly projected teeth, and eight planar teeth. It will be appreciated that in alternate examples blade 100 can include more or fewer of the upwardly projected teeth, the downwardly projected teeth, and/or the planar teeth.

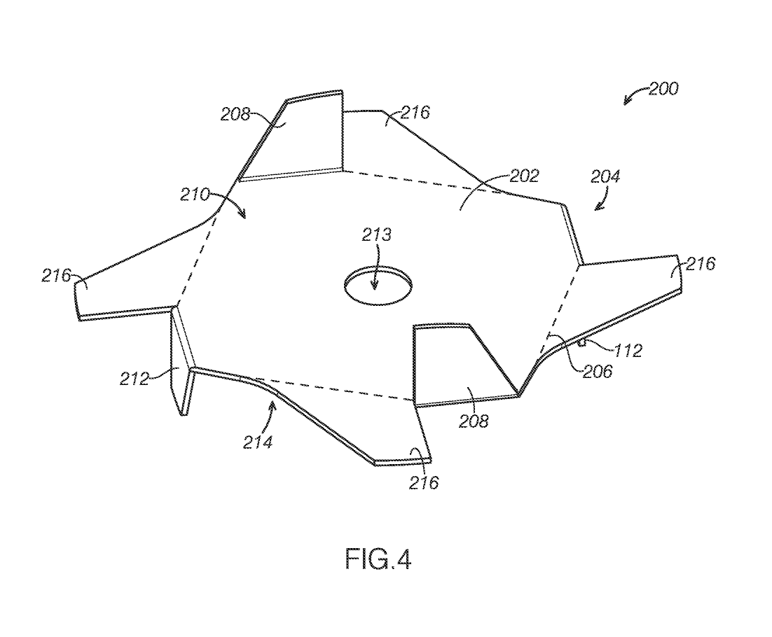

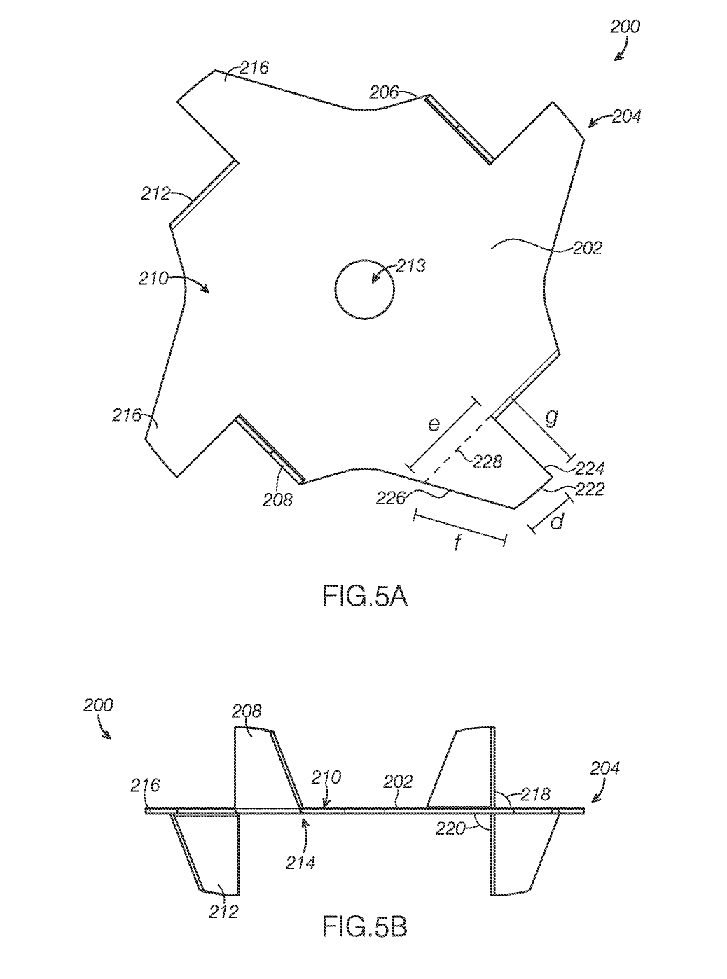

Turning attention to FIGS. 4-5B, a second example of a brush cutting blade, blade 200, will now be described. Blade 200 includes many similar or identical features to blade 100. Thus, for the sake of brevity, each feature of blade 200 will not be redundantly explained. Rather, key distinctions between blade 200 and blade 100 will be described in detail and the reader should reference the discussion above for features substantially similar between the two brush cutting blades.

As can be seen in FIGS. 4-5B, blade 200 includes a planar main body 202 and teeth 204 on a periphery 206 of the planar main body. Teeth 204 include a plurality of upwardly projected teeth 208 proximal to a first face 210 of the planar main body, a plurality of downwardly projected teeth 212 proximal to a second opposing face 214, and a plurality of planar teeth 216. Planar teeth 216 are substantially aligned with (i.e., in the same plane as) planar main body 202. Further, upwardly projected teeth 208 are upwardly disposed relative to planar main body 202, while downwardly projected teeth 212 are downwardly disposed relative to planar main body 202. Further, a center of the planar main body includes a hole 213 for attachment of the blade to a brush cutting device, such as brush cutting device 10 shown in FIG. 1.

It will be appreciated that, in the example of blade 200, the upwardly projected teeth and the downwardly projected teeth have a substantially similar configuration on opposing sides (i.e., opposing faces) of planar main body 202. Accordingly, the terms “upwardly” and “downwardly” are used merely to describe the orientation shown in the figures and the blade can be disposed at any desired orientation. In one specific example, the blade can be flipped such that the opposing face of the blade is upwardly disposed. In this example, teeth 208 can be downwardly disposed, while teeth 212 are upwardly disposed.

Furthermore, in the present example, each of planar teeth 216 are alternatingly disposed between one of upwardly projected teeth 208 and one of downwardly projected teeth 212, and the teeth are evenly spaced on the periphery of the planar main body. Accordingly, the teeth are evenly disposed in a specific distribution pattern (i.e., one of the upwardly projected teeth adjacent to one of the planar teeth, which is adjacent to one of the downwardly projected teeth, etc.). In alternate examples, the teeth can be unevenly spaced and/or the have a different distribution pattern (e.g., one of the upwardly projected teeth, one of the downwardly projected teeth, one of the planar teeth, etc.).

FIG. 5B shows that upwardly projected teeth 208 are disposed at an angle 218 relative to first face 210 and downwardly projected teeth 212 are disposed at an angle 220 relative to second face 214. Angles 218 and 220 can be in the range of 45°-135°. In the present example, angles 218 and 220 are substantially 90° angles. Further in the present example, angles 218 and 220 are substantially identical for each of teeth 209 and 212. In alternate examples, angles 218 and 220 can be greater or less than 90° (e.g., 45°, 135°, etc.). Additionally or alternatively, in alternate examples, the upwardly projected and downwardly projected teeth can be disposed at varied angles relative to the planar main body.

Also depicted in FIGS. 5A and 5B, each of teeth 208, 212, and 216 have a substantially similar shape relative to each other. Differently from blade 100, in blade 200, each of the teeth has a generally rectangular trapezoidal configuration including a linear outer edge 222, a linear perpendicular side edge 224, a linear sloped side edge 226, and an inner edge 228 where each of the teeth is connected and/or coextensive with periphery 206. Linear outer edge 222 has a width d and the opposing inner edge 228 has a width e, while linear sloped side edge 226 has a length f and linear perpendicular side edge 224 has a length g. In one specific example, the width d is 1 in., the width e is 2 in., the length f is 2 in., and the length g is 1⅞ in.

Further, in the example of blade 200, the blade includes two upwardly projected teeth, two downwardly projected teeth, and four planar teeth. It will be appreciated that in alternate examples blade 200 can include more or fewer of the upwardly projected teeth, the downwardly projected teeth, and/or the planar teeth.

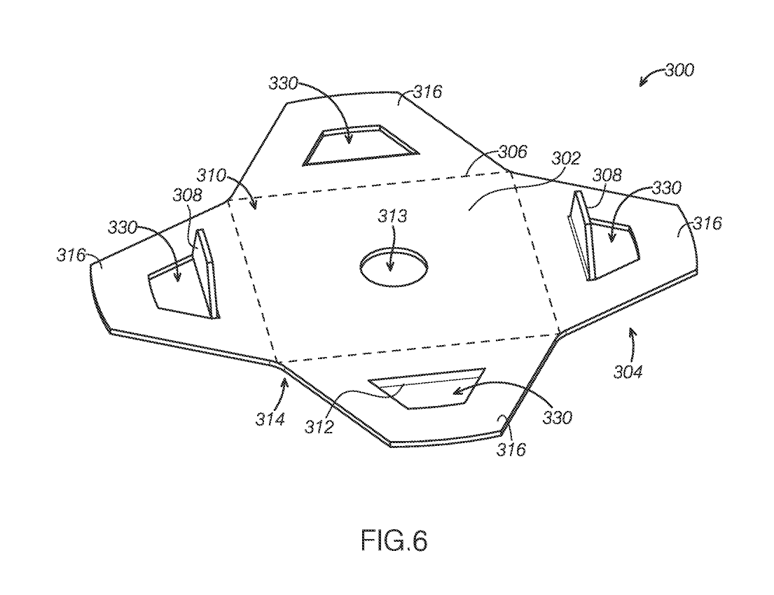

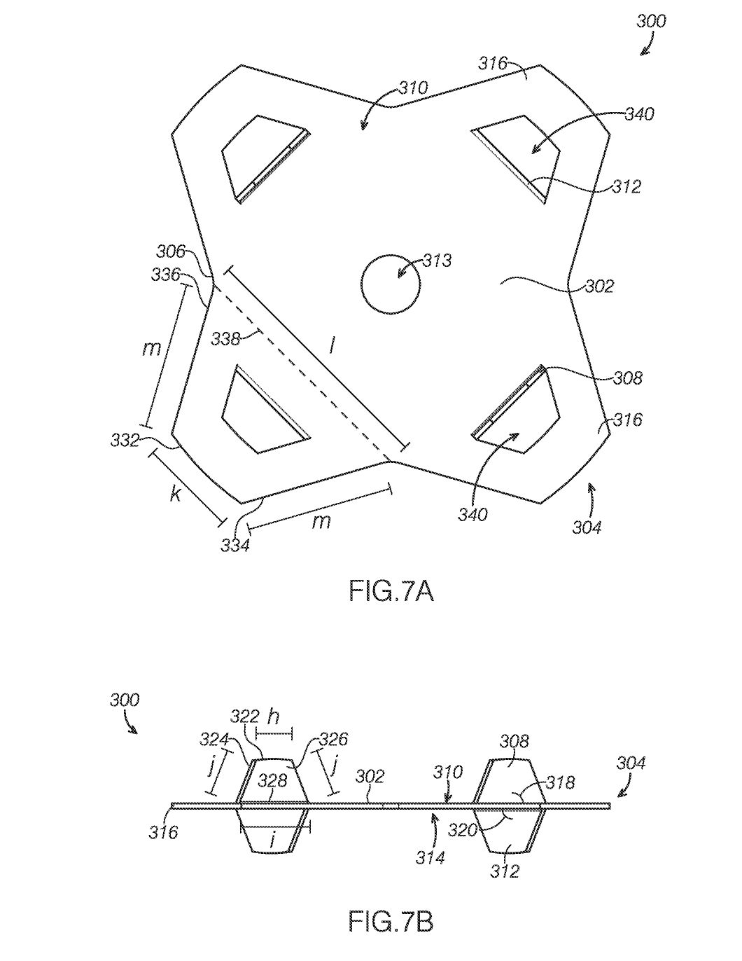

Turning attention to FIGS. 6-7B, a third example of a brush cutting blade, blade 300, will now be described. Blade 300 includes many similar or identical features to blades 100 and 200. Thus, for the sake of brevity, each feature of blade 300 will not be redundantly explained. Rather, key distinctions between blade 300 and blades 100 and 200 will be described in detail and the reader should reference the discussion above for features substantially similar between the brush cutting blades.

As can be seen in FIGS. 6-7B, blade 300 includes a planar main body 302 and teeth 304 on and/or proximal to a periphery 306 of the planar main body. Teeth 304 include a plurality of upwardly projected teeth 308 proximal to a first face 310 of the planar main body, a plurality of downwardly projected teeth 312 proximal to a second opposing face 314, and a plurality of planar teeth 316. Planar teeth 316 are substantially aligned with (i.e., in the same plane as) planar main body 302. Further, upwardly projected teeth 308 are upwardly disposed relative to planar main body 302, while downwardly projected teeth 312 are downwardly disposed relative to planar main body 302. Further, a center of the planar main body includes a hole 313 for attachment of the blade to a brush cutting device, such as brush cutting device 10 shown in FIG. 1.

It will be appreciated that, in the example of blade 300, the upwardly projected teeth and the downwardly projected teeth have a substantially similar configuration on opposing sides (i.e., opposing faces) of planar main body 302. Accordingly, the terms “upwardly” and “downwardly” are used merely to describe the orientation shown in the figures and the blade can be disposed at any desired orientation. In one specific example, the blade can be flipped such that the opposing face of the blade is upwardly disposed. In this example, teeth 308 can be downwardly disposed, while teeth 312 are upwardly disposed.

As can be seen in FIGS. 6-7B, each of planar teeth 316 are disposed on and evenly spaced on periphery 306 of planar main body 302. Unlike blades 100 and 200, one of upwardly projected teeth 308 and downwardly projected teeth 312 is disposed in planar body 308 generally aligned with a center of each of planar teeth 316. In other words, each of the upwardly projected teeth and downwardly projected teeth is a “cut out” portion of one of the planar teeth. Accordingly, an opening 340 having the same shape and size as one of the upwardly or downwardly projected teeth is disposed in planar body 302 generally aligned with a center of each of planar teeth 316.

Further, the teeth are evenly disposed in a specific distribution pattern (i.e., one of the planar teeth including one of the upwardly projected teeth adjacent to one of the planar teeth including one of the downwardly projected teeth, etc.). In alternate examples, the teeth can be unevenly spaced and/or the have a different distribution pattern.

FIG. 7B shows that upwardly projected teeth 308 are disposed at an angle 318 relative to first face 310 and downwardly projected teeth 312 are disposed at an angle 320 relative to second face 314. Angles 318 and 320 can be in the range of 45°-135°. In the present example, angles 318 and 320 are substantially 90° angles. Further in the present example, angles 318 and 320 are substantially identical for each of teeth 308 and 312. In alternate examples, angles 318 and 320 can be greater or less than 90° (e.g., 45°, 135°, etc.). Additionally or alternatively, in alternate examples, the upwardly and downwardly projected teeth can be disposed at varied angles relative to the planar main body.

Also depicted in FIGS. 7A and 7B, each of upwardly and downwardly projected teeth 308 and 312 have a substantially similar shape and size relative to each other. Further, each of planar teeth 316 has a substantially similar shape and size relative to each other. Furthermore, each of the planar teeth has a similar shape as each of the upwardly and downwardly projected teeth; however, each of the planar teeth is larger than each of the upwardly and downwardly projected teeth.

Specifically, each of the teeth has a generally regular trapezoidal configuration. Each of upwardly and downwardly projected teeth 308 and 312 includes a slightly curved outer edge 322, sloped linear side edges 324 and 326, and an inner edge 328 where each of the teeth is connected to one of planar teeth 316. Each of planar teeth 316 includes a slightly curved outer edge 332, sloped linear side edges 334 and 336, and an inner edge 338 where each of the teeth is connected to periphery 306.

Each of the teeth outwardly narrows. Accordingly, widths b and k of curved outer edges 322 and 332 are less than widths i and l of inner edges 326 and 336, respectively. Each of the side edges 324 and 326 has a length j, while each of the side edges 334 and 336 has a length m. In one specific example, the width b is ¾ in., the width i is 4 in., the length j is ¾ in., the width k is 1½ in., the width l is 1½ in., and the length m is 2½ in.

Further, in the example of blade 300, the blade includes two upwardly projected teeth, two downwardly projected teeth, and four planar teeth. It will be appreciated that in alternate examples blade 300 can include more or fewer of the upwardly projected teeth, the downwardly projected teeth, and/or the planar teeth.

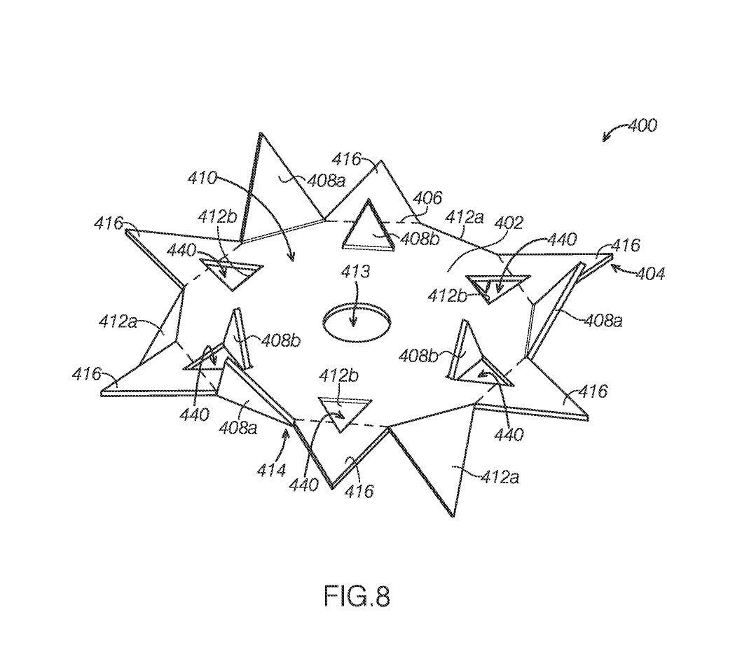

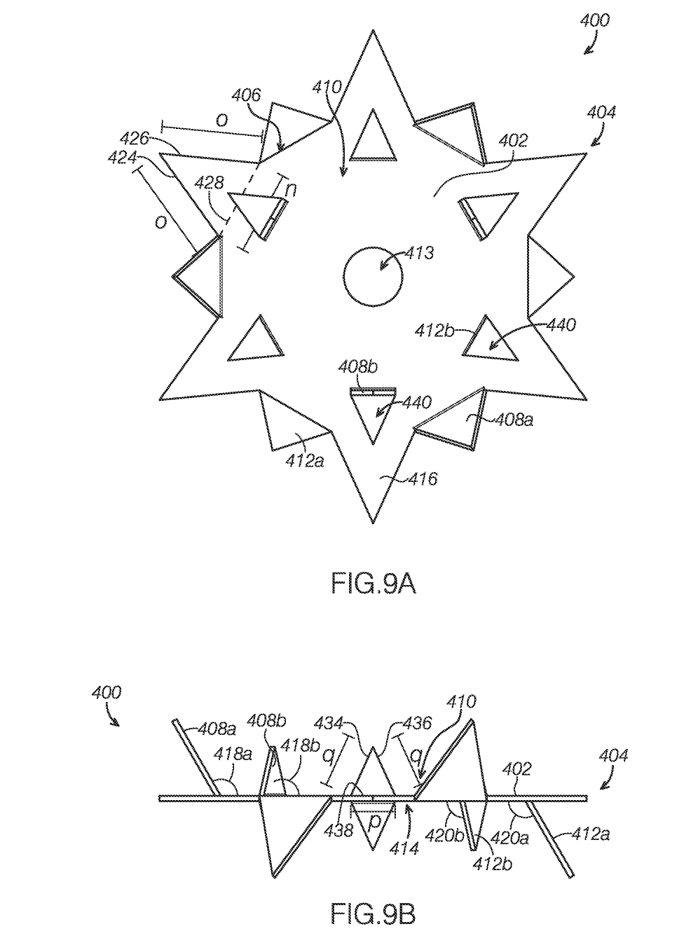

Turning attention to FIGS. 8-9B, a fourth example of a brush cutting blade, blade 400, will now be described. Blade 400 includes many similar or identical features to blades 100, 200, and 300. Thus, for the sake of brevity, each feature of blade 400 will not be redundantly explained. Rather, key distinctions between blade 400 and blades 100, 200, and 300 will be described in detail and the reader should reference the discussion above for features substantially similar between the brush cutting blades.

As can be seen in FIGS. 8-9B, blade 400 includes a planar main body 402 and teeth 404 on and/or proximal to a periphery 406 of the planar main body. Teeth 404 include a plurality of upwardly projected teeth 408a and 408b proximal to a first face 410 of the planar main body, a plurality of downwardly projected teeth 4122a and 4112b proximal to a second opposing face 414, and a plurality of planar teeth 416. Planar teeth 416 are substantially aligned with (i.e., in the same plane as) planar main body 402. Further, upwardly projected teeth 408a and 408b are upwardly disposed relative to planar main body 402, while downwardly projected teeth 412a and 412b are downwardly disposed relative to planar main body 402.

Differently than other example blades, blade 400 includes two sets of upwardly projected teeth, an outer set (i.e., upwardly projected teeth 408a) and an inner set (i.e., upwardly projected teeth 408b). Further, blade 400 includes two sets of downwardly projected teeth, an outer set (i.e., downwardly projected teeth 412a) and an inner set (i.e., downwardly projected teeth 412b). Additional sets of teeth can increase the cutting ability of the blade. Similar to blades 100, 200, and 300, a center of the planar main body includes a hole 413 for attachment of the blade to a brush cutting device, such as brush cutting device 10 shown in FIG. 1.

It will be appreciated that, in the example of blade 400, the upwardly projected teeth and the downwardly projected teeth have a substantially similar configuration on opposing sides (i.e., opposing faces) of planar main body 402. Accordingly, the terms “upwardly” and “downwardly” are used merely to describe the orientation shown in the figures and the blade can be disposed at any desired orientation. In one specific example, the blade can be flipped such that the opposing face of the blade is upwardly disposed. In this example, teeth 408a and 408b can be downwardly disposed, while teeth 412a and 412b are upwardly disposed.

As can be seen in FIGS. 8-9B, each of planar teeth 416 are disposed on and evenly spaced on periphery 406 of planar main body 402. Similar blades 100 and 200, each of planar teeth 416 are alternatingly disposed between one of upwardly projected teeth 408a and one of downwardly projected teeth 412a, and the teeth are evenly spaced on the periphery of the planar main body. Accordingly, the teeth are evenly disposed in a specific distribution pattern (i.e., one of the upwardly projected teeth adjacent to one of the planar teeth, which is adjacent to one of the downwardly projected teeth, etc.). In alternate examples, the teeth can be unevenly spaced and/or the have a different distribution pattern (e.g., one of the upwardly projected teeth, one of the downwardly projected teeth, one of the planar teeth, etc.).

Differently from blades 100 and 200, and similarly to blade 300, one of upwardly projected teeth 408b and downwardly projected teeth 412b is disposed in planar body 402 generally aligned with a center of each of planar teeth 416. In other words, each of upwardly projected teeth 408b and downwardly projected teeth 412b is a “cut out” portion of one of the planar teeth. Accordingly, an opening 440 having the same shape and size as one of the upwardly or downwardly projected teeth is disposed in planar body 408 generally aligned with a center of each of planar teeth 316.

Further, the teeth are evenly disposed in a specific distribution pattern (i.e., one of the planar teeth including one of the upwardly projected 408b teeth adjacent to one downwardly projected teeth 412a, which is adjacent to one of the planar teeth including one of the downwardly projected teeth 408b, which is adjacent to one of the upwardly projected teeth 408a, etc.). In alternate examples, the teeth can be unevenly spaced and/or the have a different distribution pattern.

FIG. 9B shows that upwardly projected teeth 408a are disposed at an angle 418a relative to first face 410 and downwardly projected teeth 412a are disposed at an angle 420a relative to second face 414. Angles 418a and 420a can be in the range of 45°-135°. In the present example, angles 418a and 420a are substantially 60° angles. Further in the present example, angles 418a and 420a are substantially identical for each of teeth 408a and 412a. In alternate examples, angles 418a and 420a can be greater or less than 60° (e.g., 45°, 90°, 135°, etc.). Additionally or alternatively, in alternate examples, upwardly projected teeth 408a and downwardly projected teeth 412a can be disposed at varied angles relative to the planar main body.

Further, upwardly projected teeth 408b are disposed at an angle 418b relative to first face 410 and downwardly projected teeth 412b are disposed at an angle 420b relative to second face 414. Angles 418b and 420b can be in the range of 45°-135°. In the present example, angles 418a and 420a are substantially 90° angles. Further in the present example, angles 418b and 420b are substantially identical for each of teeth 408b and 412b. In alternate examples, angles 418b and 420b can be greater or less than 90° (e.g., 45°, 135°, etc.). Additionally or alternatively, in alternate examples, upwardly projected teeth 408b and downwardly projected teeth 412b can be disposed at varied angles relative to the planar main body.

Also depicted in FIGS. 9A and 9B, each of upwardly and downwardly projected teeth 408a and 412a and planar teeth 416 have a substantially similar shape and size relative to each other. Further, each of upwardly and downwardly projected teeth 408b and 412b has a substantially similar shape and size relative to each other. Furthermore, each of upwardly and downwardly projected teeth 408a and 412a and planar teeth 416 has a similar shape as each of upwardly and downwardly projected teeth 408b and 412b; however, each of upwardly and downwardly projected teeth 408a and 412a and planar teeth 416 is larger than each of upwardly and downwardly projected teeth 408b and 412b.

Specifically, each of the teeth has a generally isosceles triangular configuration. Accordingly, each of upwardly and downwardly projected teeth 408a and 412a and planar teeth 416 includes sloped linear side edges 424 and 426, and an inner edge 428 where each of the teeth is connected to periphery 406. Each of upwardly and downwardly projected teeth 408b and 412b includes sloped linear side edges 434 and 436, and an inner edge 438 where each of the teeth is connected to planar body 402 (in alignment with planar teeth 416.

As shown in FIG. 9A, linear side edges 424 and 426 have a length o, while inner edge 428 has a width n. As shown in FIG. 9B, linear side edges 434 and 436 have a length q, while inner edge 438 has a width p. In one specific example, the length a is 2 in., the width n is 1¼ in., the length q is 1½ in., and the width p is 1¼ in.

Further, in the example of blade 400, the blade includes three upwardly projected teeth for each of the inner set and the outer set, three downwardly projected teeth for each of the inner set and the outer set, and six planar teeth. It will be appreciated that in alternate examples blade 400 can include more or fewer of the upwardly projected teeth, the downwardly projected teeth, and/or the planar teeth.

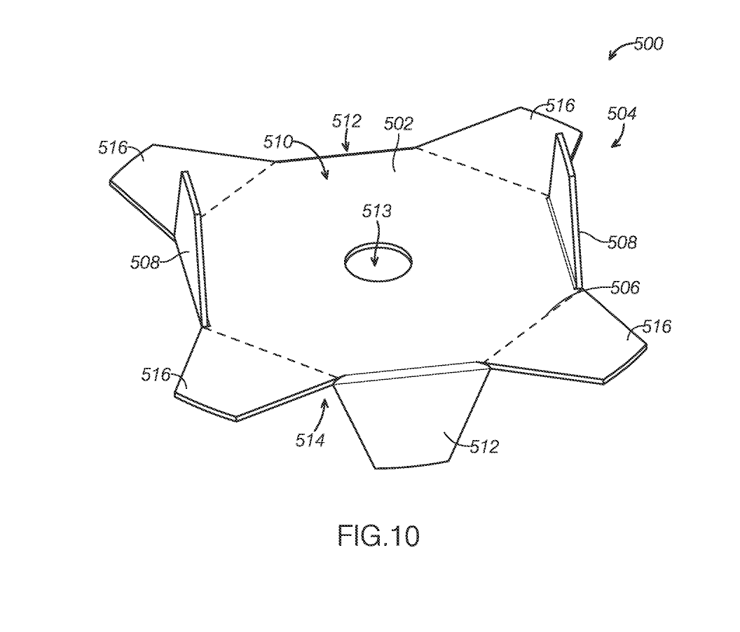

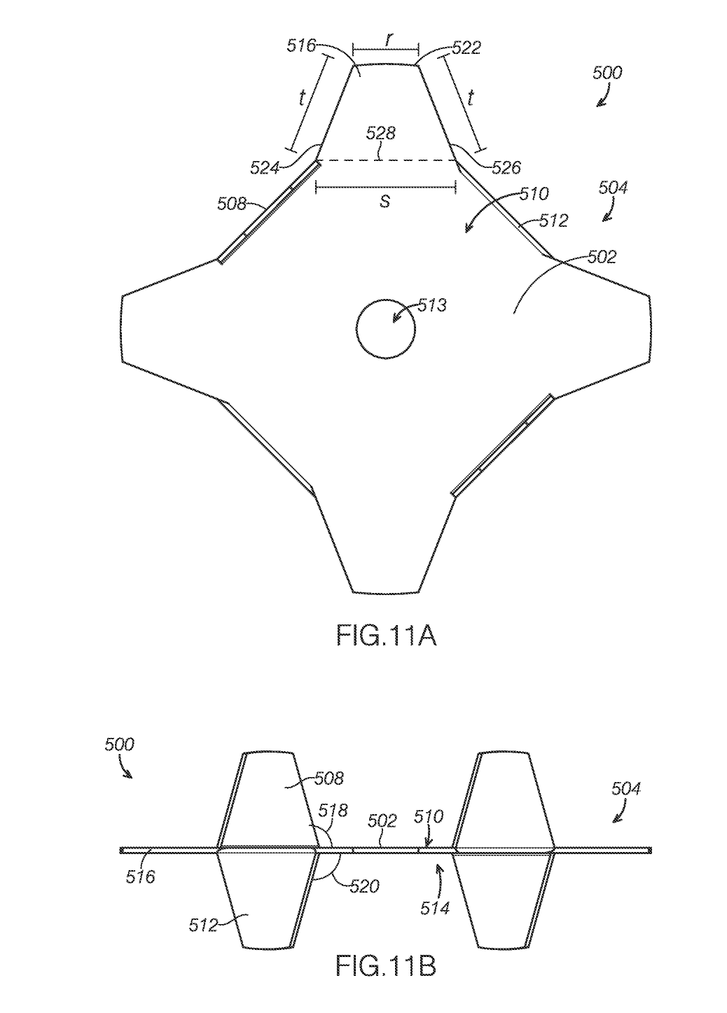

Finally, turning attention to FIGS. 10-11B, a fifth example of a brush cutting blade, blade 500, will now be described. Blade 500 includes many similar or identical features to blades 100, 200, 300, and 400. Thus, for the sake of brevity, each feature of blade 500 will not be redundantly explained. Rather, key distinctions between blade 500 and blades 100, 200, 300, and 400 will be described in detail and the reader should reference the discussion above for features substantially similar between the brush cutting blades.

As can be seen in FIGS. 10-11B, blade 500 includes a planar main body 502 and teeth 504 on and/or proximal to a periphery 506 of the planar main body. Teeth 504 include a plurality of upwardly projected teeth 508 proximal to a first face 510 of the planar main body, a plurality of downwardly projected teeth 512 proximal to a second opposing face 514, and a plurality of planar teeth 516. Planar teeth 516 are substantially aligned with (i.e., in the same plane as) planar main body 502. Further, upwardly projected teeth 508 are upwardly disposed relative to planar main body 502, while downwardly projected teeth 512 are downwardly disposed relative to planar main body 502. Further, a center of the planar main body includes a hole 513 for attachment of the blade to a brush cutting device, such as brush cutting device 10 shown in FIG. 1.

It will be appreciated that, in the example of blade 500, the upwardly projected teeth and the downwardly projected teeth have a substantially similar configuration on opposing sides (i.e., opposing faces) of planar main body 502. Accordingly, the terms “upwardly” and “downwardly” are used merely to describe the orientation shown in the figures and the blade can be disposed at any desired orientation. In one specific example, the blade can be flipped such that the opposing face of the blade is upwardly disposed. In this example, teeth 508 can be downwardly disposed, while teeth 512 are upwardly disposed.

Similarly to blades 100 and 200, each of planar teeth 516 is alternatingly disposed between one of upwardly projected teeth 508 and one of downwardly projected teeth 512, and the teeth are evenly spaced on the periphery of the planar main body. Accordingly, the teeth are evenly disposed in a specific distribution pattern (i.e., one of the upwardly projected teeth adjacent to one of the planar teeth, which is adjacent to one of the downwardly projected teeth, etc.). In alternate examples, the teeth can be unevenly spaced and/or the have a different distribution pattern (e.g., one of the upwardly projected teeth, one of the downwardly projected teeth, one of the planar teeth, etc.).

FIG. 11B shows that upwardly projected teeth 508 are disposed at an angle 518 relative to first face 510 and downwardly projected teeth 512 are disposed at an angle 520 relative to second face 514. Angles 518 and 520 can be in the range of 45°-135°. In the present example, angles 518 and 520 are substantially 90° angles. Further in the present example, angles 518 and 520 are substantially identical for each of teeth 508 and 512. In alternate examples, angles 518 and 520 can be greater or less than 90°(e.g., 45°, 135°, etc.). Additionally or alternatively, in alternate examples, the upwardly and downwardly projected teeth can be disposed at varied angles relative to the planar main body.

Also depicted in FIGS. 11A and 11B, each of upwardly and downwardly projected teeth 508 and 512 and planar teeth 516 have a substantially similar shape and size relative to each other. Furthermore, each of the planar teeth has a similar shape as each of the upwardly and downwardly projected teeth; however, each of the planar teeth is larger than each of the upwardly and downwardly projected teeth.

Specifically, each of the teeth has a generally regular trapezoidal configuration. Each of upwardly and downwardly projected teeth 508 and 512 includes a slightly curved outer edge 522, sloped linear side edges 524 and 526, and an inner edge 528 where each of the teeth is connected to periphery 506.

Each of the teeth outwardly narrows. Accordingly, a width r of curved outer edge 522 is less than a width s of inner edge 526. Each of the side edges 524 and 526 has a length t. In one specific example, the width r is 1¼ in., the width s is 2 in., and the length t is 2 in.

Further, in the example of blade 500, the blade includes two upwardly projected teeth, two downwardly projected teeth, and four planar teeth. It will be appreciated that in alternate examples blade 500 can include more or fewer of the upwardly projected teeth, the downwardly projected teeth, and/or the planar teeth.

In each of the above brush cutting blade examples, there are an equal number of upwardly projected teeth and downwardly projected teeth. Further, a total number of the upwardly and downwardly projected teeth is equal to the number of planar teeth. Each of the teeth is located on or proximal to a periphery of the planar blade body, which has a generally circular shape. Teeth located on opposing sides of the planar blade body have an identical configuration (i.e., one of the upwardly projected teeth opposes another of the upwardly projected teeth, one of the downwardly projected teeth opposes another of the downwardly projected teeth, one of the planar teeth opposes another of the planar teeth, etc.).

Furthermore, as stated above, the teeth are evenly distributed around a periphery of the planar blade body. Accordingly, during high speed rotation of the blade, the rotation occurs in a balanced and smooth manner that allows for the brush cutting device to be easily manipulated by a user. Further still, cutting of brush occurs in the horizontal plane (in the plane of the planar blade body), as well as in the vertical plane (above and below the planar blade body according to a length of the upwardly and downwardly projected teeth). It will be appreciated that the various edges of the teeth (e.g., side edges, top edges, etc.) are “cutting” edges for piercing, slicing, and/or chopping plant material. Further, in example blades including “cutouts” (blades 300 and 400), the various edges of the “cutouts” can additionally be “cutting” edges.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A brush cutting blade, comprising:
a planar main body;
one or more upwardly projected teeth upwardly disposed relative to the planar main body; and
one or more downwardly projected teeth downwardly disposed relative to the planar main body.

2. The blade of claim 1, wherein the blade is releasably attachable to a brush cutting device configured to drive rotation of the blade.

3. The blade of claim 1, wherein the one or more upwardly projected teeth and the one or more downwardly projected teeth are disposed on a periphery of the planar main body.

4. The blade of claim 1, wherein the one or more upwardly projected teeth and the one or more downwardly projected teeth are alternatingly disposed on a periphery of the planar main body.

5. The blade of claim 1, further comprising one or more planar teeth aligned with the planar main body.

6. The blade of claim 5, wherein the one or more planar teeth are alternatingly disposed between the one or more upwardly projected teeth and the one or more downwardly projected teeth on a periphery of the planar main body.

7. The blade of claim 1, wherein one of the one or more upwardly projected teeth is disposed on an opposing side of the periphery relative to another of the one or more upwardly projected teeth.

8. The blade of claim 1, wherein one of the one or more upwardly projected teeth is disposed on an opposing side of the periphery relative to another of the one or more upwardly projected teeth.

9. The blade of claim 1, wherein the one or more upwardly projected teeth are disposed at an angle between 45 degrees and 135 degrees relative to the planar main body.

10. The blade of claim 9, wherein the one or more upwardly projected teeth are disposed at a 90 degree angle relative to the planar main body.

11. The blade of claim 1, wherein the one or more downwardly projected teeth disposed at an angle between 45 degrees and 135 degrees relative to the planar main body.

12. The blade of claim 11, wherein the one or more downwardly projected teeth are disposed at a 90 degree angle relative to the planar main body.

13. A blade, comprising:
a planar main body;
one or more upwardly projected teeth upwardly disposed relative to the planar main body on a periphery of the planar main body; and
one or more downwardly projected teeth downwardly disposed relative to the planar main body on the periphery of the planar main body,
wherein the blade is attachable to a brush clearing device configured to drive rotation of the blade.

14. The blade of claim 13, wherein the one or more upwardly projected teeth and the one or more downwardly projected teeth are alternatingly disposed on the periphery of the planar main body.

15. The blade of claim 13, further comprising one or more planar teeth aligned with the planar main body.

16. The blade of claim 15, wherein the one or more planar teeth are alternatingly disposed between the one or more upwardly projected teeth and the one or more downwardly projected teeth on a periphery of the planar main body.

17. The blade of claim 13, wherein one of the one or more upwardly projected teeth is disposed on an opposing side of the periphery relative to another of the one or more upwardly projected teeth, and
one of the one or more upwardly projected teeth is disposed on an opposing side of the periphery relative to another of the one or more upwardly projected teeth.

18. The blade of claim 13, wherein the one or more upwardly projected teeth and the one or more downwardly projected teeth are disposed at an angle between 45 degrees and 135 degrees relative to the planar main body.

19. The blade of claim 18, wherein the one or more upwardly projected teeth and the one or more downwardly projected teeth are disposed at a 90 degree angle relative to the planar main body.

20. A blade that is attachable to a brush clearing device configured to drive rotation of the blade, comprising:
a planar main body;
one or more upwardly projected teeth upwardly disposed relative to the planar main body;
one or more downwardly projected teeth downwardly disposed relative to the planar main body on; and
one or more planar teeth aligned with the planar main body,
wherein the one or more planar teeth are alternatingly disposed between the one or more upwardly projected teeth and the one or more downwardly projected teeth on a periphery of the planar main body,
wherein the one or more upwardly projected teeth and the one or more downwardly projected teeth are each disposed at an angle between 45 degrees and 135 degrees relative to the planar main body,
wherein one of the one or more upwardly projected teeth is disposed on an opposing side of the periphery relative to another of the one or more upwardly projected teeth, and
wherein one of the one or more upwardly projected teeth is disposed on an opposing side of the periphery relative to another of the one or more upwardly projected teeth.
